(19) United States
(12) Patent Application Publication
(10) Pub. No.: US 2023/0198397 A1
(43) Pub. Date: Jun. 22, 2023

(54) SWITCHING POWER SUPPLY DEVICE, SWITCH CONTROL DEVICE, VEHICLE-MOUNTED APPLIANCE, AND VEHICLE

(71) Applicant: Rohm Co., Ltd., Kyoto (JP)

(72) Inventors: Shingo Hashiguchi, Kyoto (JP); Isao Takobe, Kyoto (JP); Kosuke Sato, Kyoto (JP); Yuhei Yamaguchi, Kyoto (JP)

(21) Appl. No.: 17/925,529

(22) PCT Filed: May 28, 2021
(86) PCT No.: PCT/JP2021/020345

§ 371 Date: Nov. 15, 2022

(30) Foreign Application Priority Data
Jun. 4, 2020 (JP) 2020097976
Jun. 4, 2020 (JP) 2020097977

(51) Int. Cl. H02M 3/158; H02M 1/00

(52) U.S. Cl. CPC H02M 3/158; H02M 1/0025; H02M 1/0009; H02M 1/0022

(57) ABSTRACT

A switching power supply device includes first and second switches connected in series between an application terminal for an input voltage and an application terminal for a voltage lower than the input voltage, and a controller configured to turn on and off the first and second switches. The controller has a first state where it keeps the first switch on and the second switch off, followed by a second state where it keeps the first switch off and the second switch on, followed by a third state where it keeps the first and second switches off, followed by a fourth state where it keeps the voltage at the connection node between the first and second switches lower than in the third state. The controller repeats the first, second, third, and fourth states at a fixed cycle.

### TECHNICAL FIELD

The invention disclosed herein relates to switching power supply devices that buck an input voltage to produce an output voltage, as well as to switch control devices, vehicle-mounted appliances, and vehicles.

### BACKGROUND ART

As switching power supply devices with high efficiency under light loads, fixed-on-time switching power supply devices are known (see, for example, Patent Document 1).

On the other hand, in buck switching power supply devices that buck an input voltage to produce an output voltage, generally, if the output current falls abruptly, the output voltage exhibits an overshoot.

### CITATION LIST

### Patent Literature

Patent Document 1: JP 2010-35316
Patent Document 2: U.S. Pat. No. 6,271,651 (Line 2-45 in Column 5)

### SUMMARY OF INVENTION

### Technical Problem

A fixed-on-time switching power supply device has a characteristic of its switching frequency varying according to the state of the load. As the switching frequency varies, the frequency of noise also varies, and this may diminish the effect of a noise reduction scheme (e.g., filter circuit) for suppressing noise with a fixed frequency. It is therefore preferable that the switching frequency of a switching power supply device used in an environment susceptible to noise be fixed.

Increasing the capacitance of an output capacitor may help suppress an overshoot in the output voltage, but doing so leads to increased size and cost of the device. Thus, a scheme that can suppress an overshoot in the output voltage with no increase in the capacitance of the output capacitor is desired.

Patent Document 2 discloses a switching power supply device that suppresses an undershoot and an overshoot in the output voltage by switching a short-circuiting switch connected in parallel with an inductor between an on state and an off state, or by changing the on-resistance of a short-circuiting switch connected in parallel with an inductor.

Inconveniently, the switching power supply device disclosed in Patent Document 2, when suppressing an overshoot in the output voltage, turns on both the short-circuiting switch and a rectifying switch. As a result, a current flows from the load to the ground via the short-circuiting switch and the rectifying switch, and this causes a great loss.

Moreover, the switching power supply device disclosed in Patent Document 2 requires that the short-circuiting switch have a withstand voltage comparable with those of a power switch and the rectifying switch. Thus, implementing the short-circuiting switch with a silicon device ends up in it having a large size.

### Solution to Problem

According to a first aspect of what is disclosed herein, a switching power supply device configured to buck an input voltage to produce an output voltage includes: a first switch of which the first terminal is configured to be connectable to an application terminal for the input voltage and of which the second terminal is configured to be connectable to the first terminal of an inductor; a second switch of which the first terminal is configured to be connectable to the first terminal of the inductor and to the second terminal of the first switch and of which the second terminal is configured to be connectable to an application terminal for a low voltage lower than the input voltage; and a controller configured to turn on and off the first and second switches. The controller has a first state in which the controller keeps the first switch on and the second switch off, a second state that follows the first state and in which the controller keeps the first switch off and the second switch on, a third state that follows the second state and in which the controller keeps the first and second switches off, and a fourth state that follows the third state and in which the controller keeps the voltage at the connection node between the first and second switches lower than in the third state. The controller repeats the first, second, third, and fourth states at a fixed cycle.

According to a second aspect of what is disclosed herein, a switching power supply device configured to buck an input voltage to produce an output voltage includes: a first switch of which the first terminal is configured to be connectable to an application terminal for the input voltage and of which the second terminal is configured to be connectable to the first terminal of an inductor; a second switch of which the first terminal is configured to be connectable to the first terminal of the inductor and to the second terminal of the first switch and of which the second terminal is configured to be connectable to an application terminal for a low voltage lower than the input voltage; a third switch of which the first terminal is configured to be connectable to the second terminal of the inductor and of which the second terminal is configured to be connectable to the application terminal for the low voltage; a fourth switch of which the first terminal is configured to be connectable to the second terminal of the inductor and to the first terminal of the third switch and of which the second terminal is configured to be connectable to an application terminal for the output voltage; a detector configured to detect occurrence of or a sign of occurrence of an overshoot in the output voltage; and a controller configured to turn on and off the first, second, third, and fourth switches. When occurrence of or a sign of occurrence of an overshoot in the output voltage is detected by the detector, the controller keeps the first and fourth switches off and the second and third switches on.

According to a third aspect of what is disclosed herein, a switch control device turns on and off: a first switch of which the first terminal is configured to be connectable to an application terminal for an input voltage and of which the second terminal is configured to be connectable to the first terminal of an inductor; and a second switch of which the first terminal is configured to be connectable to the first terminal of the inductor and to the second terminal of the first switch and of which the second terminal is configured to be connectable to an application terminal for a low voltage lower than the input voltage. The switch control device has a first state in which the switch control device keeps the first switch on and the second switch off, a second state that follows the first state and in which the switch control device keeps the first switch off and the second switch on, a third state that follows the second state and in which the switch control device keeps the first and second switches off, and a fourth state that follows the third state and in which the switch control device keeps the voltage at the connection node between the first and second switches lower than in the third state. The switch control device repeats the first, second, third, and fourth states at a fixed cycle.

According to a fourth aspect of what is disclosed herein, a switch control device turns on and off: a first switch of which the first terminal is configured to be connectable to an application terminal for an input voltage and of which the second terminal is configured to be connectable to the first terminal of an inductor; a second switch of which the first terminal is configured to be connectable to the first terminal of the inductor and to the second terminal of the first switch and of which the second terminal is configured to be connectable to an application terminal for a low voltage lower than the input voltage; a third switch of which the first terminal is configured to be connectable to the second terminal of the inductor and of which the second terminal is configured to be connectable to the application terminal for the low voltage; a fourth switch of which the first terminal is configured to be connectable to the second terminal of the inductor and to the first terminal of the third switch and of which the second terminal is configured to be connectable to an application terminal for the output voltage. The switch control device includes: an acquirer configured to acquire the result of detection by a detector for detecting occurrence of or a sign of occurrence of an overshoot in the output voltage; and a suppressor configured to turn on and off the first, second, third, and fourth switches based on the result of detection acquired by the acquirer and, when occurrence of or a sign of occurrence of an overshoot in the output voltage is detected by the detector, keep the first and fourth switches off and the second and third switches on to suppress the overshoot in the output voltage.

According to another aspect of what is disclosed herein, a vehicle-mounted appliance includes a switching power supply device of any of the configurations described above or a switch control device of any of the configurations described above.

According to another aspect of what is disclosed herein, a vehicle includes the vehicle-mounted appliance configured as described above and a battery for supplying the vehicle-mounted appliance with electric power.

### Advantageous Effects of Invention

According to a first feature of what is disclosed herein, it is possible to achieve high efficiency without varying the switching frequency.

According to a second feature of what is disclosed herein, it is possible to suppress an overshoot in the output voltage of a switching power supply device.

### BRIEF DESCRIPTION OF DRAWINGS

FIG. 1 is a diagram showing the configuration of a switching power supply device according to a first embodiment.

FIG. 2 is a timing chart showing the operation of the switching power supply device according to the first embodiment.

FIG. 3 is a diagram showing the configuration of a switching power supply device according to a second embodiment

FIG. 4 is a timing chart showing the operation of the switching power supply device according to the second embodiment.

FIG. 5 is a diagram showing the configuration of a switching power supply device according to a third embodiment

FIG. 6 is a timing chart showing the operation of the switching power supply device according to the third embodiment.

FIG. 7 is a diagram showing the configuration of a switching power supply device according to a fourth embodiment

FIG. 8 is a timing chart showing the operation of the switching power supply device according to the fourth embodiment.

FIG. 9 is a diagram showing a configuration example of a switching power supply device according to a fifth embodiment.

FIG. 10 is a timing chart showing an example of the operation of the switching power supply device according to the fifth embodiment on occurrence of an overshoot in the output voltage.

FIG. 11 is a diagram showing how an inductor current is regenerated.

FIG. 12 is a timing chart of a load current.

FIG. 13 is a timing chart showing another example of the operation of the switching power supply device according to the fifth embodiment on occurrence of an overshoot in the output voltage.

FIG. 14 is a diagram showing how an inductor current is regenerated.

FIG. 15 is a diagram showing how an inductor current flows from the ground via the body diode of a second switch to an inductor.

FIG. 16 is a diagram showing the waveforms of an inductor current and a switching voltage.

FIG. 17 is a diagram showing how an inductor current is regenerated.

FIG. 18 is a diagram showing how an inductor current flows from an inductor via the body diode of a first switch to an application terminal for the input voltage.

FIG. 19 is a diagram showing the waveforms of an inductor current and a switching voltage.

FIG. 20 is an exterior view showing one configuration example of a vehicle.

### DESCRIPTION OF EMBODIMENTS

In the present description, a MOS transistor denotes a transistor with a gate structure comprising at least the following three layers: a “layer of a conductive material or of a semiconductor with a low resistance value such as polysilicon”; an “insulating layer”; and a “layer of a p-type, n-type, or intrinsic semiconductor”. That is, the gate structure of a MOS transistor is not limited to a three-layer structure comprising a metal, an oxide, and a semiconductor.

### 1. First Embodiment

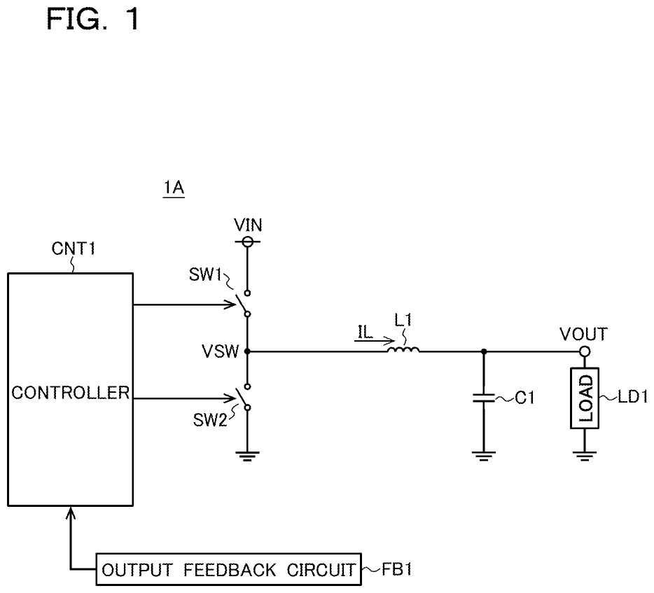

FIG. 1 is a diagram showing the configuration of a switching power supply device according to a first embodiment. The switching power supply device 1A according to the first embodiment (hereinafter “switching power supply device 1A”) is a switching power supply device that bucks (steps down) an input voltage VIN to produce an output voltage VOUT. The switching power supply device 1A includes a controller CNT1, a first switch SW1, a second switch SW2, an inductor L1, an output capacitor C1, and an output feedback circuit FB1. The switching power supply device 1A may be configured to operate in a continuous current mode under a light load, or may be configured to include a reverse current prevention function and operate in a discontinuous current mode under a light load.

The controller CNT1 turns on and off the first and second switches SW1 and SW2 based on the output of the output feedback circuit FB1. In other words, the controller CNT1 is a switch control device that turns on and off the first and second switches SW1 and SW2.

The first switch SW1 has a first terminal configured to be connectable to an application terminal for the input voltage VIN, and has a second terminal configured to be connectable to the first terminal of the inductor L1. The first switch SW1 switches between a conducting state and a cut-off state the current path leading from the application terminal for the input voltage VIN to the inductor L1. The first switch SW1 can be implemented with, for example, a P-channel MOS transistor or an N-channel MOS transistor. In a case where the first switch SW1 is implemented with an N-channel MOS transistor, the switching power supply device 1A may additionally include a bootstrap circuit for generating a voltage higher than the input voltage VIN.

The second switch SW2 has a first terminal configured to be connectable to the first terminal of the inductor L1 and to the second terminal of the first switch SW1, and has a second terminal configured to be connectable to an application terminal for a ground potential. The second switch SW2 switches between a conducting state and a cut-off state the current path leading from the application terminal for the ground potential to the inductor L1. The second switch SW2 can be implemented with, for example, an N-channel MOS transistor.

Through the switching of the first and second switches SW1 and SW2, a switching voltage VSW with a pulse waveform appears at the connection node between the first and second switches SW1 and SW2. The inductor L1 and the output capacitor C1 smooth the switching voltage VSW with a pulse waveform to produce the output voltage VOUT, and supplies the output voltage VOUT to an application terminal for the output voltage VOUT. To the application terminal for the output voltage VOUT, a load LD1 is connected, so that the load LD1 is supplied with the output voltage VOUT.

The output feedback circuit FB1 generates and outputs a feedback signal commensurate with the output voltage VOUT. The output feedback circuit FB1 can be implemented with, for example, a resistor voltage division circuit that divides the output voltage VOUT with resistors to produce a feedback signal. For another example, the output feedback circuit FB1 may be configured to acquire the output voltage VOUT and outputs it as it is as a feedback signal. The output feedback circuit FB1 may be configured to generate and output, in addition to a feedback signal commensurate with the output voltage VOUT, a feedback signal commensurate with the current through the inductor L1 (hereinafter “inductor current IL”). Using an output feedback circuit FB1 that generates a feedback signal commensurate with the inductor current IL as well, it is possible to perform current-mode control.

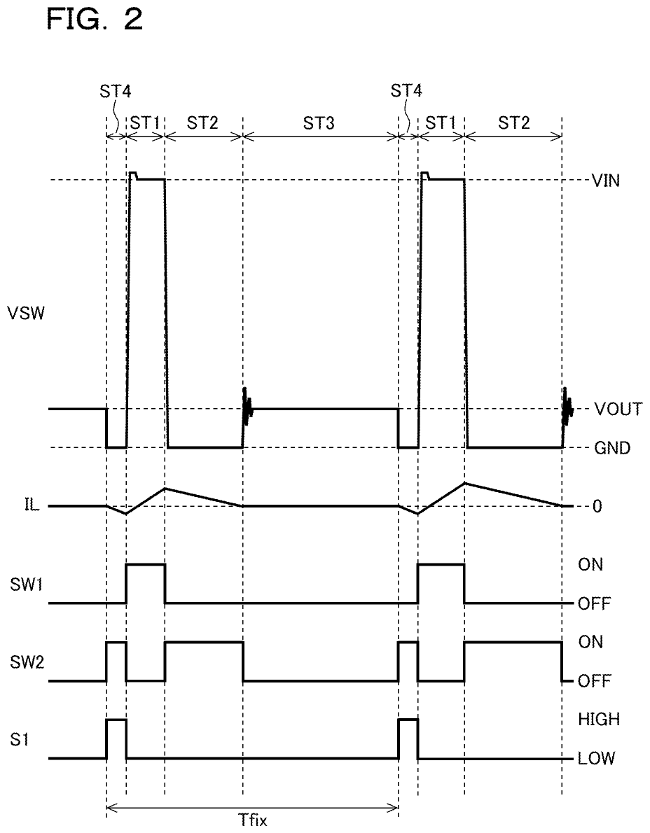

FIG. 2 is a timing chart showing the operation of the switching power supply device 1A. According to the feedback signal output from the output feedback circuit FB1, the controller CNT1 sets the length of a first state ST1. As the load LD1 is lighter, the first state ST1 is set to be shorter.

In the first state ST1, the controller CNT1 keeps the first switch SW1 on and the second switch SW2 off. In the first state ST1, the switching voltage VSW first rises to a value equal to the sum of the input voltage VIN and the forward voltage of the body diode of the first switch SW1 and then settles to a value approximately equal to the input voltage VIN. In the first state ST1, the inductor current IL increases as time passes.

At the end of the first state ST1, the controller CNT1 switches control states from the first state ST1 to a second state ST2.

In the second state ST2, the controller CNT1 keeps the first switch SW1 off and the second switch SW2 on. In the second state ST2, the switching voltage VSW has a value approximately equal to the ground potential GND. In the second state ST2, the inductor current IL decreases as time passes.

When the inductor current IL has decreased to a predetermined value, the controller CNT1 ends the second state ST2, and switches control states from the second state ST2 to a third state ST3. A checker (not illustrated) that checks whether the inductor current IL has decreased down to the predetermined value may be provided separately from the controller CNT1, or may be incorporated in the controller CNT1. In this embodiment, the predetermined value mentioned above is zero.

In the third state ST3, the controller CNT1 keeps the first and second switches SW1 and SW2 off. In the third state ST3, the connection node between the first and second switches SW1 and SW2 is in a high-impedance state, and the switching voltage VSW has a value approximately equal to that of the output voltage VOUT. In the third state ST3, the inductor current IL is zero.

A periodic signal S1 is a signal in which pulses appear at a fixed cycle Tfix. The periodic signal S1 may be a signal generated within the controller CNT1, or may be a signal generated outside the controller CNT1 and is acquired by the controller CNT1.

When a pulse rises in the periodic signal S1, the controller CNT1 ends the third state ST3, and switches control states from the third state ST3 to a fourth state ST4.

In the fourth state ST4, the controller CNT1 keeps the first switch SW1 off and the second switch SW2 on. In the fourth state ST4, the switching voltage VSW has a value approximately equal to that of the ground potential GND. In the fourth state ST4, the inductor current IL flows from the application terminal for the output voltage VOUT to the connection node between the first and second switches SW1 and SW2, and increases as time passes. In the fourth state ST4, the inductor current IL is generated. The energy resulting from regeneration of the inductor current IL is released on transition from the fourth state ST4 to the first state ST1; thus, on transition from the fourth state ST4 to the first state ST1, the switching voltage VSW rises abruptly.

When the pulse falls in the periodic signal S1, the controller CNT1 ends the fourth state ST4, and switches control states from the fourth state ST4 to the first state ST1.

The controller CNT1 repeats the first, second, third, and fourth states ST1, ST2, ST3, and ST4 at the fixed cycle Tfix. It is preferable that dead time periods in which the first and second switches SW1 and SW2 are both off be provided one between the first and second states ST1 and ST2 and one between the fourth and first states ST4 and ST1. In a case where dead time periods are provided one between the first and second states ST1 and ST2 and one between the fourth and first states ST4 and ST1, the fixed cycle Tfix equals the total of the following periods added together: the first state ST1, the dead time period between the first and second states ST1 and ST2, the second state ST2, the third state ST3, the fourth state ST4, and the dead time period between the fourth and first states ST4 and ST1.

The switching power supply device 1A is configured to operate at the fixed cycle Tfix and not to produce loss in the third state ST3, and thus achieves high efficiency without varying the switching frequency. As the load LD1 is lighter, the first state ST1 is shorter and the third state ST3 is longer; thus the switching power supply device 1A helps greatly improve efficiency under a light load LD1.

In a modified example of this embodiment, the second switch SW2 may have the second terminal configured to be connectable to an application terminal for a low voltage lower than the input voltage VIN and different from the ground potential.

### 2. Second Embodiment

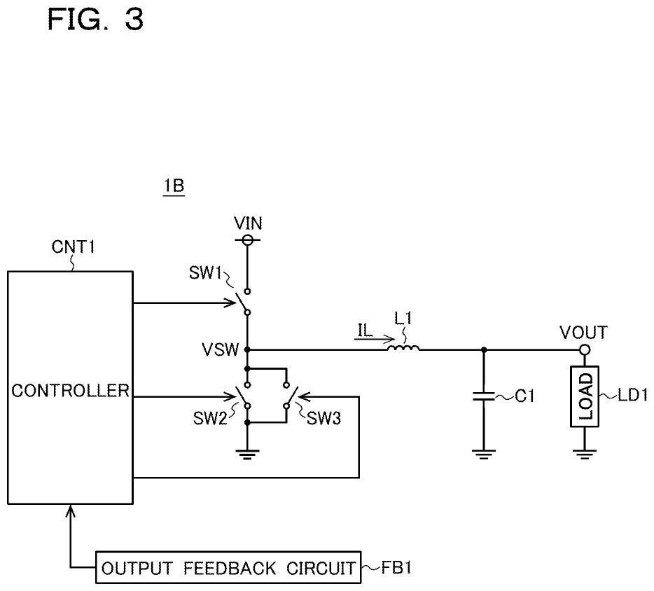

With respect to a second embodiment, no overlapping description will be repeated for such elements and features as are similar to those in the first embodiment. FIG. 3 is a diagram showing the configuration of a switching power supply device according to the second embodiment. The switching power supply device 1B according to the second embodiment (hereinafter “switching power supply device 1B”) results from adding a switch SW3 to the switching power supply device 1A.

The switch SW3 is connected in parallel with the switch SW2. That is, the first terminal of the switch SW3 is connected to the first terminal of the switch SW2, and the second terminal of the switch SW3 is connected to the second terminal of the switch SW2. The third switch SW3 can be implemented with, for example, an N-channel MOS transistor. The controller CNT1 not only turns on and off the first and second switches SW1 and SW2 but also turns on and off the third switch SW3.

The switch SW3 has at least either of a lower on-state resistance (the resistance between the first and second terminals in the on state) and a lower capacitance (the parasitic capacitance between the first and second terminals) than the switch SW2.

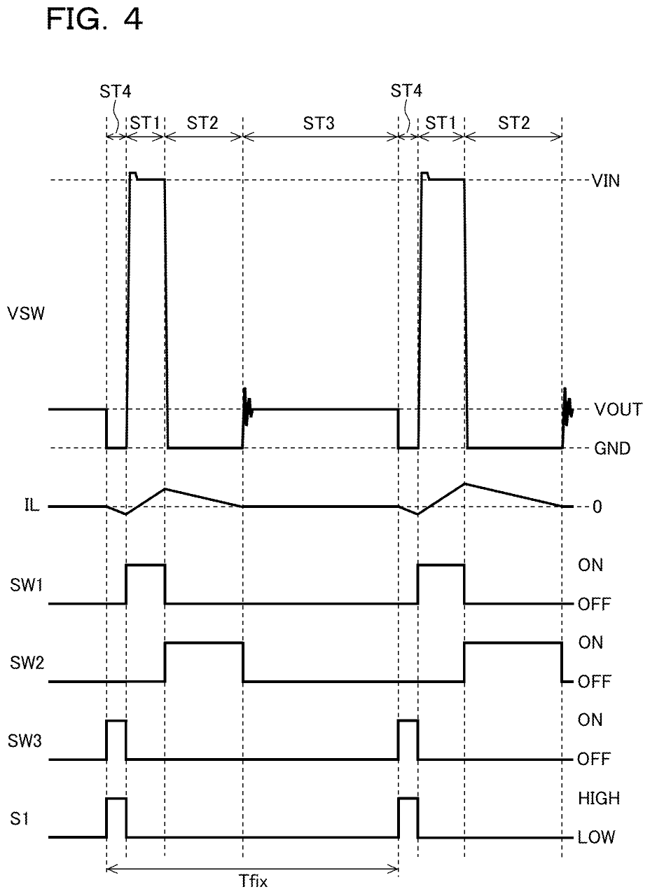

FIG. 4 is a timing chart showing the operation of the switching power supply device 1B. The operation of the switching power supply device 1B differs from that of the switching power supply device 1A in that, in the fourth state ST4, the controller CNT1 keeps the second switch SW2 off

In the fourth state ST4, the controller CNT1 keeps, instead of the second switch SW2, the third switch SW3 on. As mentioned above, the switch SW3 has at least either of a lower on-state resistance and a lower capacitance than the switch SW2. Thus, the switching power supply device 1B produces less loss in the fourth state ST4 than the switching power supply device 1A.

In the first, second, and third states ST1, ST2, and ST3, the controller CNT1 keeps the third switch SW3 off

The switching power supply device 1B is configured to operate at the fixed cycle Tfix and not to produce loss in the third state ST3, and thus achieves high efficiency without varying the switching frequency. As the load LD1 is lighter, the first state ST1 is shorter and the third state ST3 is longer; thus the switching power supply device 1B helps greatly improve efficiency under a light load LD1.

In a modified example of this embodiment, in the fourth state ST4, the controller CNT1 may keep the second and third switches SW2 and SW3 both on.

In another modified example of this embodiment, the second and third switches SW2 and SW3 may have their respective second terminals configured to be connectable to an application terminal for a low voltage lower than the input voltage VIN and different from the ground potential.

### 3. Third Embodiment

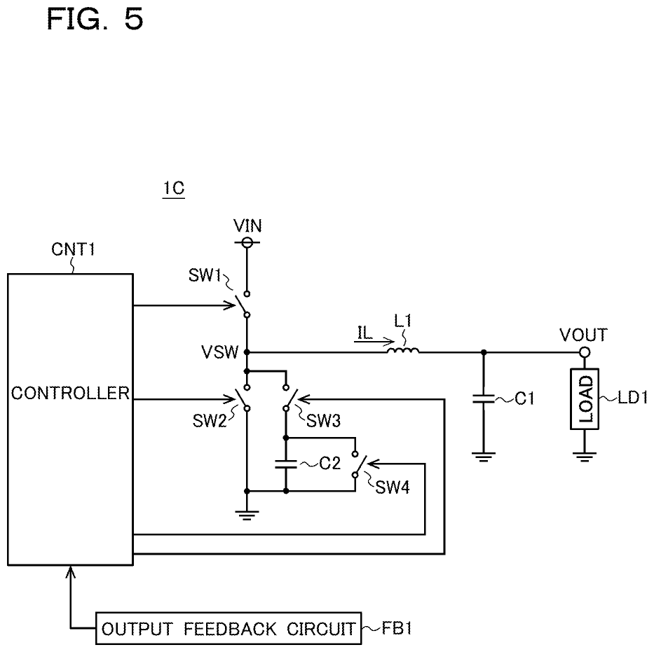

With respect to a third embodiment, no overlapping description will be repeated for such elements and features as are similar to those in the second embodiment. FIG. 5 is a diagram showing the configuration of a switching power supply device according to the third embodiment. The switching power supply device 1C according to the third embodiment (hereinafter “switching power supply device 1C”) results from adding a switch SW3, a capacitance C2, and a switch SW4 to the switching power supply device 1A.

The first terminal of the switch SW3 is connected to the connection node between the first and second switches SW1 and SW2. The second terminal of the switch SW3 is connected to the first terminal of the capacitance C2 and to the first terminal of the fourth switch SW4. The second terminal of the capacitance C2 and the second terminal of the fourth switch SW4 are connected to the ground potential. The third switch SW3 can be implemented with, for example, an N-channel MOS transistor. The fourth switch SW4 can be implemented with, for example, an N-channel MOS transistor. The controller CNT1 not only turns on and off the first and second switches SW1 and SW2 but also turns on and off the third and fourth switches SW3 and SW4.

The switch SW3 has at least either of a lower on-state resistance (the resistance between the first and second terminals in the on state) and a lower capacitance (the parasitic capacitance between the first and second terminals) than the switch SW2. As opposed to the embodiment under discussion, the switch SW3 may have an on-state resistance and a capacitance largely equal to those of the switch SW2.

The switch SW4 is a switch for discharging the capacitance C2. With the switch SW4 on, the capacitance C2 is short-circuited across its terminals to be discharged.

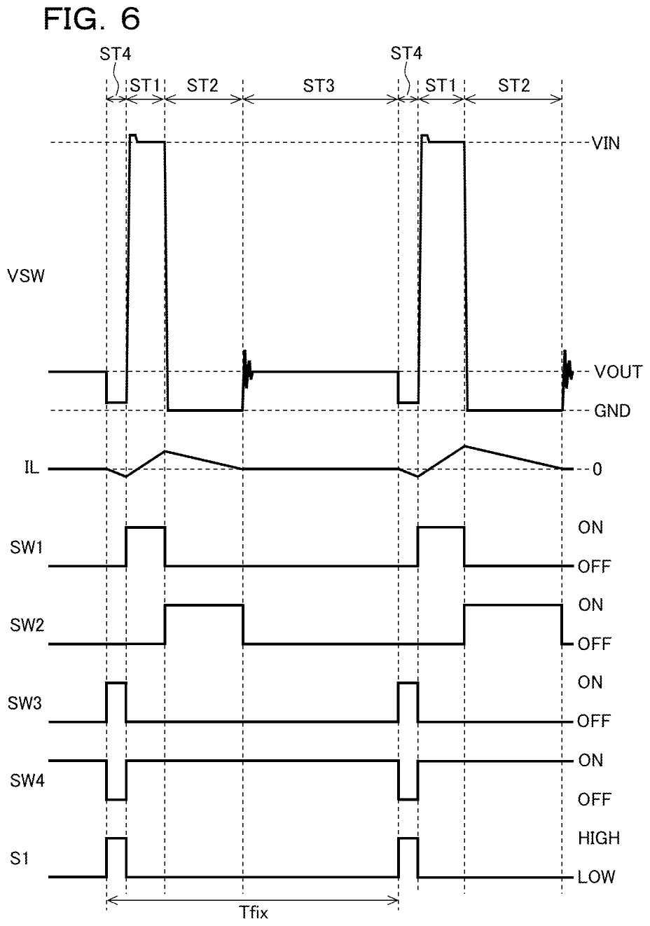

FIG. 6 is a timing chart showing the operation of the switching power supply device 1C. The switching power supply device 1C operates basically in the same way as the switching power supply device 1B. In the switching power supply device 1C, the controller CNT1 additionally turns on and off the fourth switch SW4. The controller CNT1 turns on and off the third and fourth switches SW3 and SW4 complementarily. Specifically, the controller CNT1 keeps the fourth switch SW4 on in the first, second, and third states ST1, ST2, and ST3 and keeps the fourth switch SW4 off in the fourth state ST4.

In the switching power supply device 1C, in the fourth state ST4, the switching voltage VSW is a voltage resulting from capacitance-dividing the input voltage VIN with the parasitic capacitance between the first and second terminals of the first switch SW1 and the sum of the parasitic capacitance between the first and second terminals of the third switch SW3 and the capacitance C2. Thus, through adjustment of the capacitance value of the capacitance C2, the value of the switching voltage VSW in the fourth state ST4 can be adjusted. That is, through adjustment of the capacitance value of the capacitance C2, it is possible to adjust how the switching voltage VSW rises on transition from the fourth state ST4 to the first state ST1.

For example, the controller CNT1 can be incorporated in a semiconductor integrated circuit device while the capacitance C2 is left as a component to be externally connected to it; this makes it easy to adjust the value of the switching voltage VSW in the fourth state ST4.

The switching power supply device 1C is configured to operate at the fixed cycle Tfix and not to produce loss in the third state ST3, and thus achieves high efficiency without varying the switching frequency. As the load LD1 is lighter, the first state ST1 is shorter and the third state ST3 is longer; thus the switching power supply device 1C helps greatly improve efficiency under a light load LD1.

In a modified example of this embodiment, the second switch SW2, the capacitance C2, and the fourth switch SW4 may have their respective second terminals configured to be connectable to an application terminal for a low voltage lower than the input voltage VIN and different from the ground potential.

### 4. Fourth Embodiment

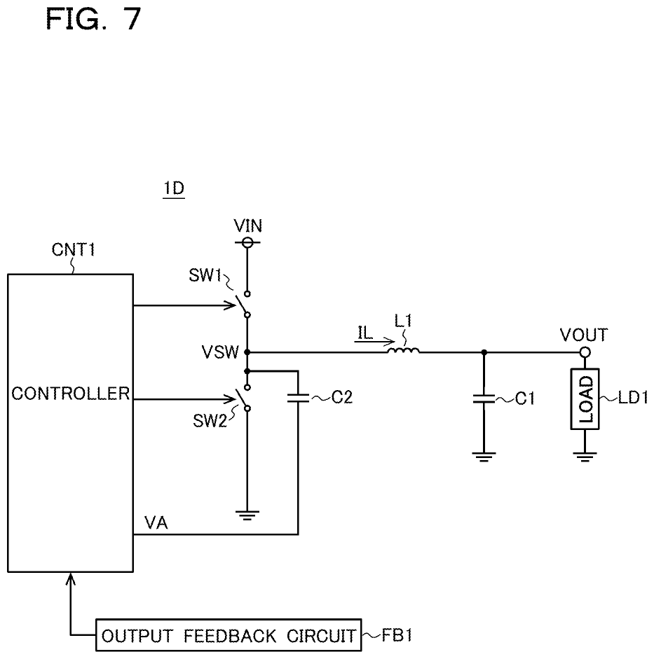

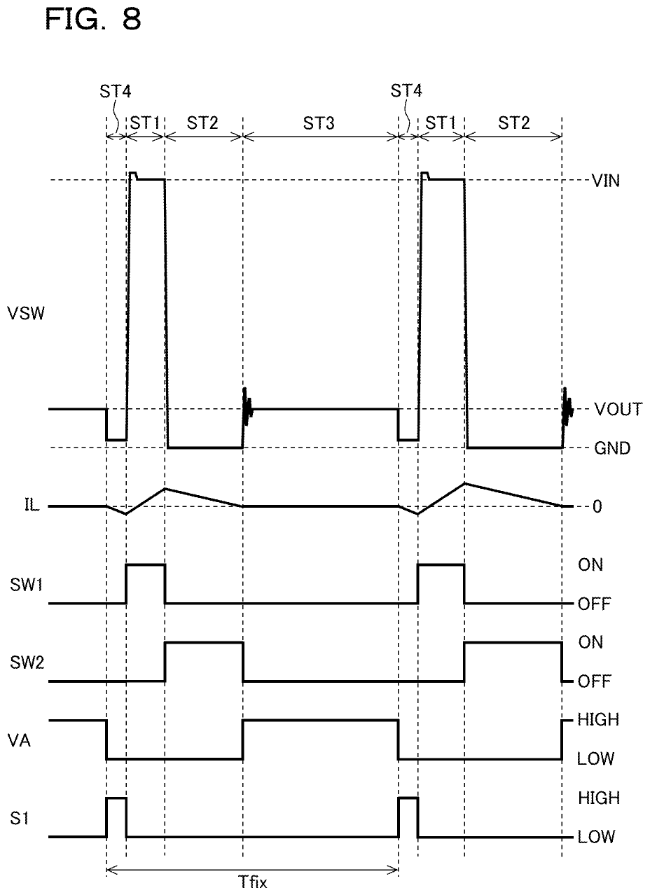

With respect to a fourth embodiment, no overlapping description will be repeated for such elements and features as are similar to those in the third embodiment. FIG. 7 is a diagram showing the configuration of a switching power supply device according to the fourth embodiment. FIG. 8 is a timing chart showing the operation of the switching power supply device according to the fourth embodiment. The switching power supply device 1D according to the fourth embodiment (hereinafter “switching power supply device 1D”) results from adding a capacitance C2 to the switching power supply device 1A.

The first terminal of the capacitance C2 is connected to the connection node between the first and second switches SW1 and SW2. The controller CNT1 controls a voltage VA that is applied to the second terminal of the switch SW3. For example, the controller CNT1 keeps the voltage VA at high level (e.g., at the same value as the output voltage VOUT) in the third state ST3 and at low level (e.g., at the ground potential GND) in the first, second, and fourth states ST1, ST2, and ST4.

Through adjustment of the value of the voltage VA in the fourth state ST4, it is possible to adjust how the switching voltage VSW rises on transition from the fourth state ST4 to the first state ST1.

The switching power supply device 1D is configured to operate at the fixed cycle Tfix and not to produce loss in the third state ST3, and thus achieves high efficiency without varying the switching frequency. As the load LD1 is lighter, the first state ST1 is shorter and the third state ST3 is longer; thus the switching power supply device 1D helps greatly improve efficiency under a light load LD1.

In a modified example of this embodiment, the second switch SW2 may have the second terminal configured to be connectable to an application terminal for a low voltage lower than the input voltage VIN and different from the ground potential.

### 5. Fifth Embodiment

<5-1. Configuration Example of a Switching Power Supply Device>

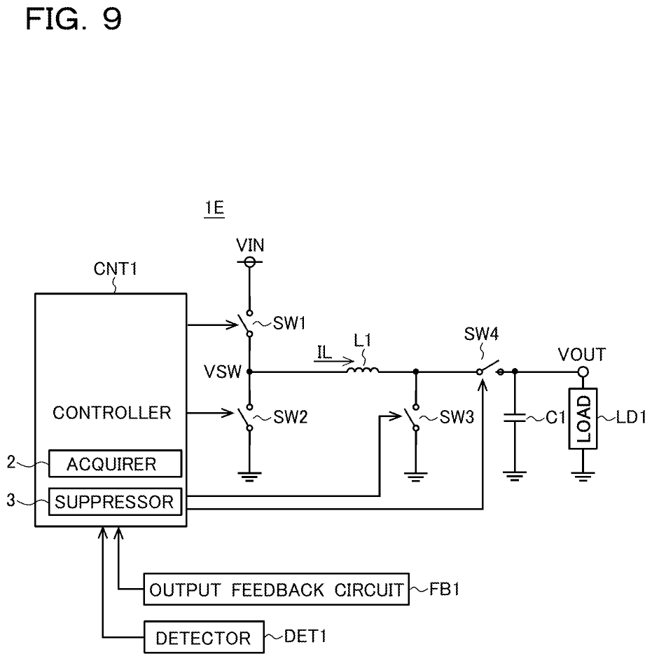

FIG. 9 is a diagram showing a configuration example of a switching power supply device according to a fifth embodiment. The switching power supply device 1E of the configuration example shown in FIG. 9 according to the fifth embodiment (hereinafter “switching power supply device 1E”) is a switching power supply device that bucks (steps down) an input voltage VIN to produce an output voltage VOUT. The switching power supply device 1E includes a controller CNT1, a first to a fourth switch SW1 to SW4, an inductor L1, an output capacitor C1, an output feedback circuit FM, and a detector DET1. The switching power supply device 1E may be configured to operate in a continuous current mode under a light load, or may be configured to include a reverse current prevention function and operate in a discontinuous current mode under a light load.

Based on the outputs from the output feedback circuit FB1 and the detector DET1 respectively, the controller CNT1 turns on and off the first to fourth switches SW1 to SW4. In other words, the controller CNT1 is a switch control device that turns on and off the first to fourth switches SW1 and SW4. The controller CNT1 includes an acquirer 2 that acquires the result of detection by the detector DET1, and a suppressor 3 that, based on the result of detection by the detector DET1 as acquired by the acquirer 2, turns on and off the first to fourth switches SW1 and SW4 and that, when the detector DET1 detects occurrence of an overshoot in the output voltage VOUT, keeps the first and fourth switches SW1 and SW4 off and the second and third switches SW2 and SW3 on to suppress the overshoot in the output voltage VOUT. The acquirer 2 and the suppressor 3 may each be implemented on a software basis or with a hardware circuit, or may be implemented by coordination between software and hardware.

The first switch SW1 has a first terminal configured to be connectable to an application terminal for the input voltage VIN, and has a second terminal configured to be connectable to the first terminal of the inductor L1. The first switch SW1 switches between a conducting state and a cut-off state the current path leading from the application terminal for the input voltage VIN to the inductor L1. The first switch SW1 can be implemented with, for example, a P-channel MOS transistor or an N-channel MOS transistor. In a case where the first switch SW1 is implemented with an N-channel MOS transistor, the switching power supply device 1E may additionally include a bootstrap circuit for generating a voltage higher than the input voltage VIN.

The second switch SW2 has a first terminal configured to be connectable to the first terminal of the inductor L1 and to the second terminal of the first switch SW1, and has a second terminal configured to be connectable to an application terminal for a ground potential. The second switch SW2 switches between a conducting state and a cut-off state the current path from the application terminal for the ground potential to the inductor L1. As opposed to the example under discussion, the second switch SW2 may have the second terminal configured to be connectable to an application terminal for a voltage lower than the input voltage VIN and different from the ground potential. It should however be noted that the voltage applied to the second terminal of the second switch SW2 is equal to the voltage applied to the second terminal of the third switch SW3. The second switch SW2 can be implemented with, for example, an N-channel MOS transistor.

Through the switching of the first and second switches SW1 and SW2, a switching voltage VSW with a pulse waveform appears at the connection node between the first and second switches SW1 and SW2. The inductor L1 and the output capacitor C1 smooth the switching voltage VSW with a pulse waveform to produce the output voltage VOUT, and supplies the output voltage VOUT to an application terminal for the output voltage VOUT. To the application terminal for the output voltage VOUT, a load LD1 is connected, so that the load LD1 is supplied with the output voltage VOUT.

The third switch SW3 has a first terminal configured to be connectable to the second terminal of the inductor L1, and has a second terminal configured to be connectable to the application terminal for the ground potential. The third switch SW3 can be implemented with, for example, an N-channel MOS transistor.

The fourth switch SW4 has a first terminal configured to be connectable to the second terminal of the inductor L1 and to the first terminal of the third switch SW3, and has a second terminal configured to be connectable to the application terminal for the output voltage VOUT. The third fourth SW4 can be implemented with, for example, an N-channel MOS transistor.

The third and fourth switches SW3 and SW4 are not fed with the input voltage VIN, and thus the third and fourth switches SW3 and SW4 can have withstand voltages lower than those of the first and second switches SW1 and SW2. This helps reduce the size of the third and fourth switches SW3 and SW4. By reducing the size of the third and fourth switches SW3 and SW4, it is possible to reduce the loss produced by the parasitic capacitances of the third and fourth switches SW3 and SW4.

The output feedback circuit FB1 generates and outputs a feedback signal commensurate with the output voltage VOUT. The output feedback circuit FB1 can be implemented with, for example, a resistor voltage division circuit that divides the output voltage VOUT with resistors to produce a feedback signal. For another example, the output feedback circuit FB1 may be configured to acquire the output voltage VOUT and outputs it as it is as a feedback signal. The output feedback circuit FB1 may be configured to generate and output, in addition to a feedback signal commensurate with the output voltage VOUT, a feedback signal commensurate with the current through the inductor L1 (hereinafter “inductor current IL”). Using an output feedback circuit FB1 that generates a feedback signal commensurate with the inductor current IL as well, it is possible to perform current-mode control.

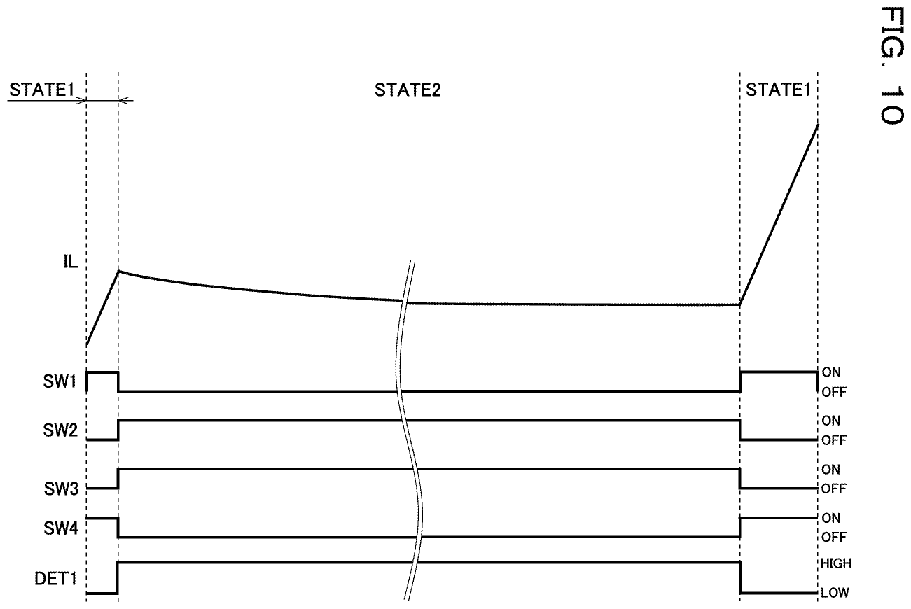

The detector DET1 detects occurrence and disappearance of an overshoot in the output voltage VOUT. The detector DET1 can be implemented with, for example, a comparator of which the non-inverting input terminal is fed with the output voltage VOUT and of which the inverting input terminal is fed with a constant voltage (a voltage higher than the target value of the output voltage VOUT). When an overshoot occurs in the output voltage VOUT, the comparator turns its output signal from low level to high level. When the overshoot in the output voltage VOUT disappears, the comparator turns its output signal from high level to low level. An example of this illustrative output signal is shown in FIG. 10, which will be referred to later.

Instead of the output voltage VOUT, a division voltage of it may be fed to the non-inverting input terminal of the comparator, and instead of the constant voltage mentioned above, a division voltage of it may be fed to the inverting input terminal of the comparator.

The comparator may be configured as a hysteresis comparator, or separate comparators may be provided for detecting occurrence of an overshoot and for detecting disappearance of an overshoot. It is thus possible to make different the value of the output voltage VOUT at which to detect occurrence of an overshoot and the value of the output voltage VOUT at which to detect disappearance of an overshoot.

The detector DET1 need not be able to detect disappearance of an overshoot. For example, the controller CNT1 may include a counter so that, after the controller CNT1 detects occurrence of an overshoot in the output voltage VOUT, when a given time as counted by the counter elapses, the controller CNT1 judges that the overshoot in the output voltage VOUT has disappeared.

As opposed to the example under discussion, the detector DET1 may be configured to detect a sign of occurrence of an overshoot in the output voltage VOUT so that, when the detector DET1 detects a sign of occurrence of an overshoot in the output voltage VOUT, the suppressor 3 described above keeps the first and second switches SW1 and SW2 off and the third switch SW3 on to suppress an overshoot in the output voltage VOUT.

One example of a method of detecting a sign of occurrence of an overshoot in the output voltage VOUT is, for example with respect to a load LD1 that varies regularly and that abruptly becomes light after a particular variation pattern, to detect a variation pattern in the load current that corresponds to that particular variation pattern.

### 5-2. Example of the Operation of a Switching Power Supply Device on Occurrence of an Overshoot in the Output Voltage

FIG. 10 is a timing chart showing an example of the operation of the switching power supply device 1E on occurrence of an overshoot in the output voltage VOUT.

When occurrence of an overshoot in the output voltage VOUT is detected by the detector DET1, under the control of the controller CNT1, the switching power supply device 1E goes into a second state STATE2. FIG. 10 is a timing chart depicting the behavior observed when, in the middle of a first state STATE1 (in the middle of an on-duty period of the switching voltage VSW), an overshoot in the output voltage VOUT is detected by the detector DET1 and the output of the detector DET1 turns from low level to high level with the result that the switching power supply device 1E makes a transition from the first state STATE1 to the second state STATE2. In the first state STATE1, under the control of the controller CNT1, the first and fourth switches are on and the second and the third switches SW2 and SW3 are off

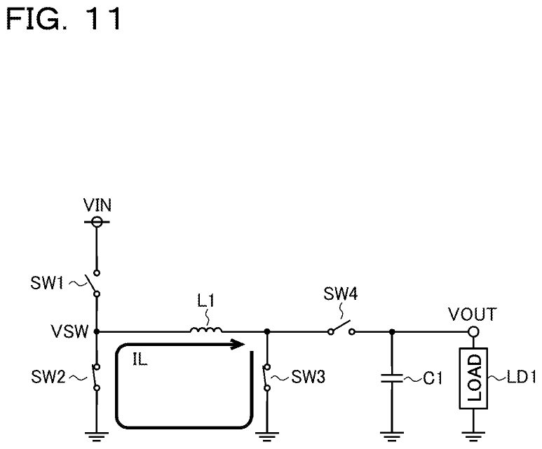

In the second state STATE2, under the control of the controller CNT1, the first and fourth switches SW1 and SW4 are off and the second and third switches SW2 and SW3 are on. When an overshoot occurs in the output voltage VOUT and the switching power supply device 1E goes into the second state STATE2, as shown in FIG. 11, the inductor current IL is regenerated around a closed circuit including the second switch SW2, the inductor L1, and the third switch SW3. This permits cutting off the supply of current to the load LD1. In second state STATE2, since the fourth switch SW4 is off, the output voltage VOUT can be clamped generally around the level at the time of occurrence of the overshoot. That is, when an overshoot occurs in the output voltage VOUT, by keeping the first and fourth switches SW1 and SW4 off and the third switches SW2 and SW3 on, it is possible to prevent a further increase in the output voltage VOUT and thereby suppress the overshoot.

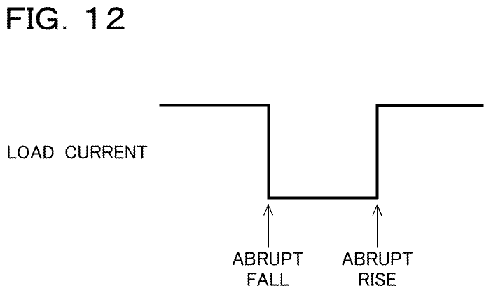

Moreover, for example, in a situation where, as shown in FIG. 12, the load current (the output current of the switching power supply device 1E) abruptly falls and then abruptly rises, while the load current is abruptly rising, the regenerated energy stored in the closed circuit including the second switch SW2, the inductor L1, and the third switch SW3 can be released toward the load LD1; it is thereby possible to suppress also an undershoot in the output voltage VOUT in response to an abrupt rise in the load current.

In the example under discussion, until disappearance of the overshoot in the output voltage VOUT is detected by the detector DET1, the switching power supply device 1E is kept in the second state STATE2. As long as the second state STATE2 is maintained, the inductor current IL decreases gradually via the on-state resistances of the second and third switches SW2 and SW3. In FIG. 10, when disappearance of the overshoot in the output voltage VOUT is detected by the detector DET1 and the output of the detector DET1 turns from high level to low level, the switching power supply device 1E makes a transition from the second state STATE2 to the first state STATE1. This transition, however, is only illustrative. That is, at the end of the second state STATE2, a transition may be made to any state other than the first state STATE1.

In the example of operation under discussion, from occurrence to disappearance of an overshoot in the output voltage VOUT, the second state STATE2 is maintained without a break. Instead, so long as an overshoot in the output voltage VOUT can be suppressed, as opposed to the example of operation under discussion, the second state STATE2 may be suspended momentarily during the period from occurrence to disappearance of an overshoot in the output voltage VOUT, or may be ended before disappearance of an overshoot in the output voltage VOUT.

### 5-3. Another Example of the Operation of a Switching Power Supply Device on Occurrence of an Overshoot in the Output Voltage

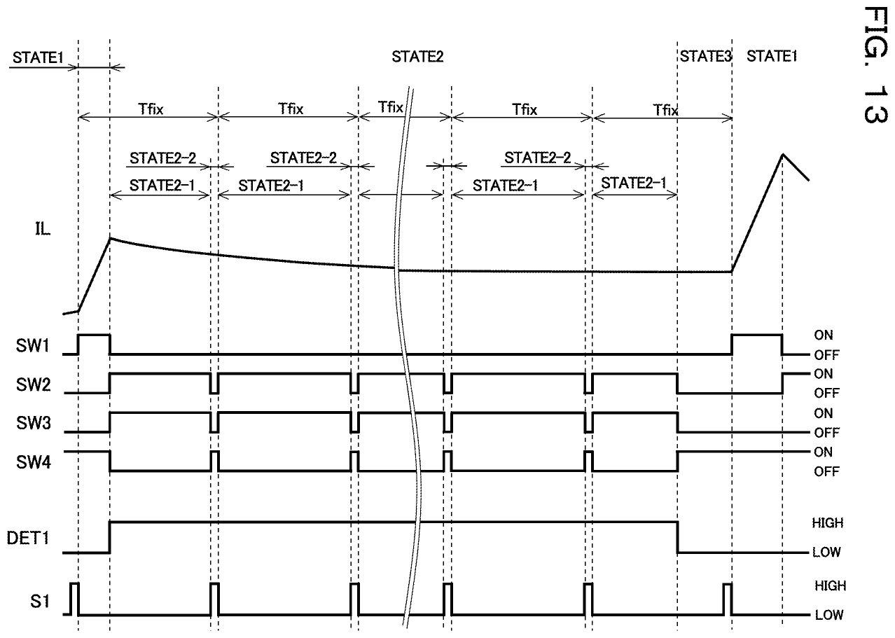

FIG. 13 is a timing chart showing another example of the operation of the switching power supply device 1E on occurrence of an overshoot in the output voltage VOUT.

When occurrence of an overshoot in the output voltage VOUT is detected by the detector DET1, under the control of the controller CNT1, the switching power supply device 1E goes into a second state STATE2. FIG. 13 is a timing chart depicting the behavior observed when, in the middle of a first state STATE1 (in the middle of an on-duty period of the switching voltage VSW), an overshoot in the output voltage VOUT is detected by the detector DET1 and the output of the detector DET1 turns from low level to high level with the result that the switching power supply device 1E makes a transition from the first state STATE1 to the second state STATE2.

In the first state STATE1, under the control of the controller CNT1, the first and second switches SW1 and SW2 turn on and off complementarily at the fixed cycle Tfix based on the periodic signal S1, the third switch SW3 is off, and the fourth switch SW4 is on. The periodic signal S1 is a signal in which pulses occur at the fixed cycle Tfix. The periodic signal S1 may be a signal generated within the controller CNT1, or may be a signal generated outside the controller CNT1 and is acquired by the controller CNT1. It is preferable that dead time periods in which the first and second switches SW1 and SW2 are both off be provided while the first and second turn on and off complementarily.

In the second state STATE2, under the control of the controller CNT1, the first switch SW1 is off, and the second to fourth switches SW2 to SW4 turn on and off at the fixed cycle Tfix. The second and third switches SW2 and SW3 together, at one end, and the fourth switch SW4, at the other end, turn on and off complementarily at the fixed cycle Tfix. In the second state STATE2, the controller CNT1 turns the second to fourth switches SW2 to SW4 on and off based on the periodic signal S1.

In the second state STATE2, two states, namely a state STATE2-1 and a state STATE2-2, are repeated at the fixed cycle Tfix. The state STATE2-1 is a period in which the second and third switches SW2 and SW3 are on and the fourth switch SW4 is off; the state STATE2-2 is a period in which the second and third switches SW2 and SW3 are off and the fourth switch SW4 is on.

In the example of operation under discussion, until disappearance of an overshoot in the output voltage VOUT is detected by the detector DET1, the switching power supply device 1E is kept in the second state STATE2. As long as the second state STATE2 is maintained, the inductor current IL decreases gradually via the on-state resistances of the second and third switches SW2 and SW3. In FIG. 13, when disappearance of the overshoot in the output voltage VOUT is detected by the detector DET1 and the output of the detector DET1 turns from high level to low level, the switching power supply device 1E makes a transition from the second state STATE2 to a third state STATE3. In the third state STATE3, under the control of the controller CNT1, the first to third switches SW1 to SW3 are off and the fourth switch SW4 is on.

In the third state STATE3, when a pulse occurs in the periodic signal S1, a transition occurs from the third state STATE3 to the first state STATE1.

Now, assuming an example where the first to fourth switches SW1 to SW4 are implemented with N-channel MOS transistors, the states STATE2-1 and STATE2-2 will be described in detail. As opposed to the example under discussion, for example, the first to fourth switches SW1 to SW4 may be implemented with bipolar transistors, with a reverse-connected diode connected in parallel with each of those bipolar transistors. The direction in which a current flows through a reverse-connected diode (i.e., the direction heading from the anode to the cathode of the reverse-connected diode) is opposite to the direction in which a current flows through the bipolar transistor in parallel with which the reverse-connected diode is connected.

First, a description will be given of a case where the inductor current IL has a positive direction.

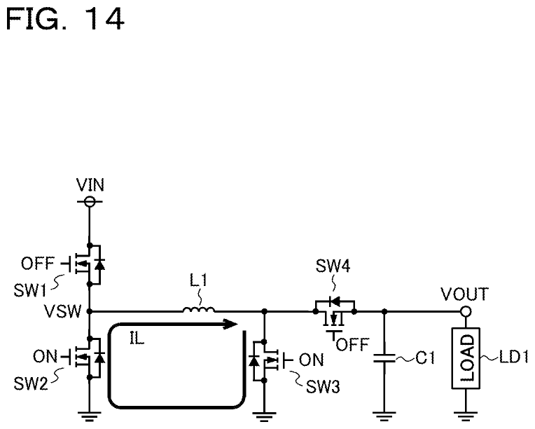

In the state STATE2-1, as shown in FIG. 14, the second and third switches SW2 and SW3 are on, and thus the inductor current IL is regenerated around a closed circuit that includes the second switch SW2, the inductor L1, and the third switch SW3, and the switching voltage VSW is approximately equal to the ground potential.

In the state STATE2-1, the fourth switch SW4 is off, and this permits cutting off the supply of current to the load LD1. Thus, the output voltage VOUT can be clamped generally around the level at the time of occurrence of an overshoot. That is, on occurrence of an overshoot in the output voltage VOUT, by keeping the first and fourth switches SW1 and SW4 off and the second and third switches SW2 and SW3 on, it is possible to prevent a further increase in the output voltage VOUT and thereby suppress the overshoot.

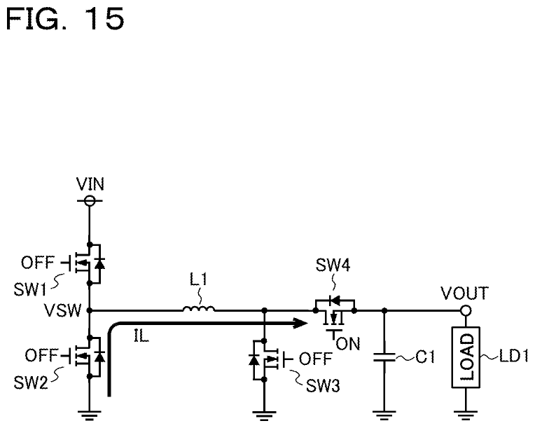

In the state STATE2-2, as shown in FIG. 15, the second and third switches SW2 and SW3 are off, and thus the inductor current IL flows from the ground via the body diode of the second switch SW2 to the inductor L1. Accordingly, the switching voltage VSW equals—Vf_{SW2}. Here, Vf_{SW2} is the forward voltage of the body diode of the second switch SW2.

In the example of operation under discussion, each period of the state STATE2-2 has a fixed duration. Specifically, the duration of each period of the state STATE2-2 is a fixed duration that corresponds to the pulse width of the periodic signal S1. It is preferable that the duration of each period of the state STATE2-2 be 1/10 or less of the fixed cycle Tfix. This is because, if the duration of each period of the state STATE2-2 is longer than 1/10 of the fixed cycle Tfix, the time required until an overshoot in the output voltage VOUT disappears exceeds the permissible range.

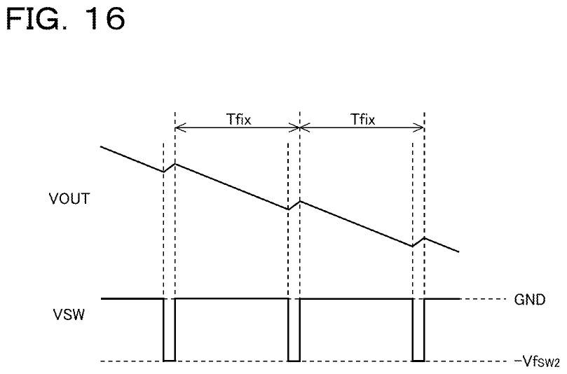

In a case where the inductor current IL has a positive direction, in the second state STATE2, the output voltage VOUT and the switching voltage VSW behave as shown in FIG. 16. It should be noted that, with respect to the vertical scale in FIG. 16, the output voltage VOUT is enlarged compared with the switching voltage VSW. As will be seen from FIG. 16, the switching voltage VSW has a fixed cycle Tfix. That is, the frequency of the switching voltage VSW (the switching frequency) does not vary, and thus the frequency of the noise ascribable to the switching frequency does not vary, either. This helps prevent diminishing the effect of a noise reduction scheme (e.g., filter circuit) for suppressing noise with a fixed frequency.

Next, a description will be given of a case where the inductor current IL has a negative direction.

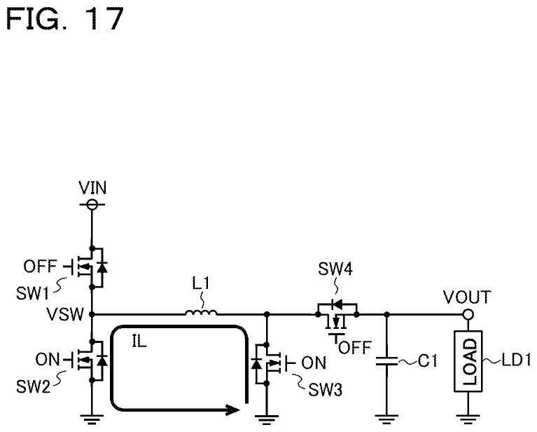

In the state STATE2-1, as shown in FIG. 17, the second and third switches SW2 and SW3 are on, and thus the inductor current IL is regenerated around a closed circuit that includes the second switch SW2, the inductor L1, and the third switch SW3. Thus the switching voltage VSW is approximately equal to the ground potential.

In the state STATE2-1, the fourth switch SW4 is off, and this permits cutting off the supply of current to the load LD1. Thus, the output voltage VOUT can be clamped generally around the level at the time of occurrence of an overshoot. That is, on occurrence of an overshoot in the output voltage VOUT, by keeping the first and fourth switches SW1 and SW4 off and the second and third switches SW2 and SW3 on, it is possible to prevent a further increase in the output voltage VOUT and thereby suppress the overshoot.

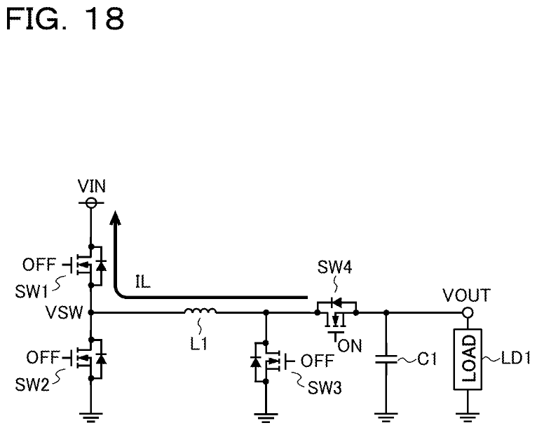

In the state STATE2-2, as shown in FIG. 18, the second and third switches SW2 and SW3 are off, and thus the inductor current IL flows from the inductor L1 via the body diode of the second switch SW1 to the application terminal for the input voltage VIN. Accordingly, the switching voltage VSW equals VIN+Vf_{SW1}. Here, Vf_{SW1} is the forward voltage of the body diode of the second switch SW1.

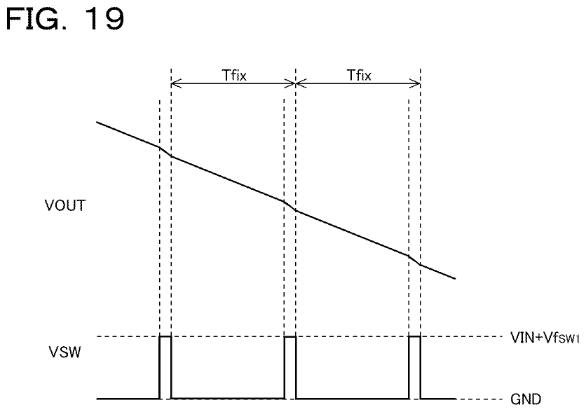

In a case where the inductor current IL has a negative direction, in the second state STATE2, the output voltage VOUT and the switching voltage VSW behave as shown in FIG. 19. It should be noted that, with respect to the vertical scale in FIG. 19, the output voltage VOUT is enlarged compared with the switching voltage VSW. As will be seen from FIG. 19, the switching voltage VSW has a fixed cycle Tfix. That is, the frequency of the switching voltage VSW (the switching frequency) does not vary, and thus the frequency of the noise ascribable to the switching frequency does not vary, either. This helps prevent diminishing the effect of a noise reduction scheme (e.g., filter circuit) for suppressing noise with a fixed frequency.

In a case where the inductor current IL has a positive direction, as opposed to the example of operation under discussion, the controller CNT1 may keep the second switch SW2 on in the state STATE2-2. In a case where the inductor current IL has a negative direction, as opposed to the example of operation under discussion, the controller CNT1 may keep the first switch SW1 on in the state STATE2-2.

The set value of the fixed cycle Tfix may be variable. The set value of the fixed cycle Tfix can be changed by changing the period of the periodic signal S1.

<6. Application>

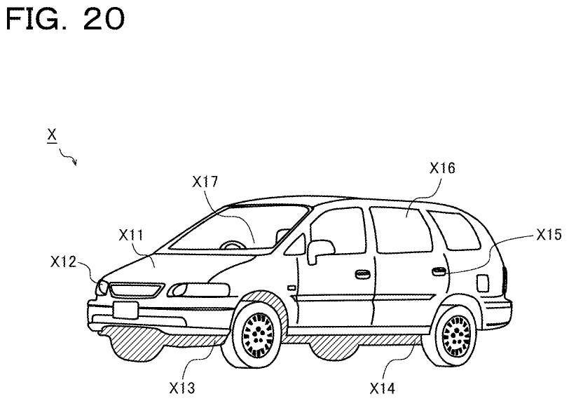

Next, an example of application of the switching power supply devices 1A to 1E described above will be described. FIG. 20 is an exterior view showing one configuration example of a vehicle that incorporates a vehicle-mounted appliance. The vehicle X of this configuration example includes vehicle-mounted appliances X11 to X17 and a battery (not illustrated) that supplies those vehicle-mounted appliances X11 to X17 with electric power.

In a case where any of the switching power supply devices 1A to 1E described above is incorporated in the vehicle X, it is required that nose emission in the AM band be reduced so as not to adversely affect reception of AM radio broadcasts. Accordingly, it is preferable that the controller CNT1 produce a voltage with a frequency of 1.8 MHz or higher but 2.1 MHz or lower at the connection node between the first and second switches SW1 and SW2. That is, it is preferable that the controller CNT1 keeps the frequency of the switching voltage VSW (the switching frequency) in a range of 1.8 MHz or higher but 2.1 MHz or lower. A switching frequency lower than 1.8 MHz leads to increased noise emission in the AM band, and a switching frequency higher than 2.1 MHz leads to switching loss exceeding the permissible range.

The vehicle-mounted appliance X11 is an engine control unit that performs control with respect to an engine (injection control, electronic throttle control, idling control, oxygen sensor heater control, automatic cruise control, etc.).

The vehicle-mounted appliance X12 is a lamp control unit that controls the lighting and extinguishing of HIDs (high-intensity discharged lamps), DRLs (daytime running lamps), and the like.

The vehicle-mounted appliance X13 is a transmission control unit that performs control with respect to a transmission.

The vehicle-mounted appliance X14 is a body control unit that performs control with respect to the movement of the vehicle X (ABS [anti-lock brake system] control, EPS [electric power steering] control, electronic suspension control, and the like).

The vehicle-mounted appliance X15 is a security control unit that drives and controls door locks, burglar alarms, and the like.

The vehicle-mounted appliance X16 comprises electronic appliances incorporated in the vehicle X as standard or manufacturer-fitted equipment at the stage of factory shipment, such as wipers, power side mirrors, power windows, a power sun roof, power seats, and an air conditioner.

The vehicle-mounted appliance X17 comprises electronic appliances fitted to the vehicle X optionally as user-fitted equipment, such as vehicle-mounted A/V (audio/visual) equipment, a car navigation system, and an ETC (electronic toll control system).

Any of the switching power supply devices 1A to 1E described above can be incorporated in any of the vehicle-mounted appliances X11 to X17.

<7. Notes>

The present invention can be implemented in any other manners than as in the embodiments described above without departure from the spirit of the invention. The embodiments described above should be considered to be in every aspect illustrative and not restrictive, and the technical scope of the present invention is defined not by the description of embodiments given above but by the scope of the appended claims and should be understood to encompass any modifications within a spirit and scope equivalent to the claims.

For example, the set value of the fixed cycle Tfix may be variable. The set value of the fixed cycle Tfix can be changed by changing the period of the periodic signal S1.

For example, in the fifth embodiment, considering that the third and fourth switches SW3 and SW4 has lower withstand voltages than the first and second switches SW1 and SW2, it is preferable to make separate an integrated circuit package that incorporates the first and second switches SW1 and SW2 and an integrated circuit package that incorporates the third and fourth switches SW3 and SW4. It is then possible to efficiently design and fabricate each of the integrated circuit packages.

Instead, the fourth switches SW1 to SW4 may be incorporated in a single integrated circuit package. Or the fourth switches SW1 to SW4 may be formed as discrete components.

There is no restrictions on which components of the switching power supply devices 1A to 1E to incorporate in an IC and which to form as discrete components.

According to a first aspect of what has been described above, a switching power supply device configured to buck an input voltage to produce an output voltage includes: a first switch of which the first terminal is configured to be connectable to an application terminal for the input voltage and of which the second terminal is configured to be connectable to the first terminal of an inductor; a second switch of which the first terminal is configured to be connectable to the first terminal of the inductor and to the second terminal of the first switch and of which the second terminal is configured to be connectable to an application terminal for a low voltage lower than the input voltage; and a controller configured to turn on and off the first and second switches. The controller has a first state in which the controller keeps the first switch on and the second switch off, a second state that follows the first state and in which the controller keeps the first switch off and the second switch on, a third state that follows the second state and in which the controller keeps the first and second switches off, and a fourth state that follows the third state and in which the controller keeps the voltage at the connection node between the first and second switches lower than in the third state. The controller repeats the first, second, third, and fourth states at a fixed cycle. (A first configuration.)

With the switching power supply device of the first configuration described above, it is possible to achieve high efficiency without varying the switching frequency.

In the switching power supply device of the first configuration described above, in the fourth state, the controller may keep the first switch off and the second switch on.

### (A Second Configuration.)

With the switching power supply device of the second configuration described above, it is possible to regenerate the current flowing through the inductor in the fourth state.

In the switching power supply device of the first or second configuration described above, there may be further provided: a third switch configured to be connectable in parallel with the second switch and having at least either of a lower on-state resistance and a lower capacitance than the second switch. The controller may be configured to turn on and off the third switch. In the fourth state, the controller may keep the first switch off and the third switch on. (A third configuration.)

With the switching power supply device of the third configuration described above, it is possible to reduce loss in the fourth state.

In the switching power supply device of the first configuration described above, there may be further provided: a third switch of which the first terminal is configured to be connectable to the first terminal of the inductor and to the second terminal of the first switch and a capacitance of which the first terminal is connected to the second terminal of the third switch and of which the second terminal is configured to be connectable to the application terminal for the low voltage. The controller may be configured to turn on and off the third switch. In the fourth state, the controller may keep the first switch off and the third switch on. (A fourth configuration.)

With the switching power supply device of the fourth configuration described above, it is possible to adjust how the switching voltage appearing at the connection node between the first and second switches rises on transition from the fourth state to the first state.

In the switching power supply device of the fourth configuration described above, there may be further provided: a fourth switch configured to be connectable in parallel with the capacitance. The controller may configured to turn on and off the fourth switch. The controller may turn on and off the third and fourth switches complementarily. (A fifth configuration.)

With the switching power supply device of the fifth configuration described above, it is possible to discharge the capacitance at an appropriate timing.

In the switching power supply device of the first configuration described above, there may be further provided: a capacitance of which the first terminal is configured to be connectable to the first terminal of the inductor and to the second terminal of the first switch and of which the second terminal is configured to be connectable to an application terminal for a variable voltage. The controller may be configured to control the variable voltage. In the fourth state, the controller may keep the first switch off and, by controlling the variable voltage, produce a voltage difference between the first and second terminals of the capacitance. (A sixth configuration.)

With the switching power supply device of the sixth configuration described above, it is possible, by adjusting the value of the variable voltage in the fourth state, to adjust how the switching voltage appearing at the connection node between the first and second switches rises on transition from the fourth state to the first state.

According to a second aspect of what has been described above, a switching power supply device configured to buck an input voltage to produce an output voltage includes: a first switch of which the first terminal is configured to be connectable to an application terminal for the input voltage and of which the second terminal is configured to be connectable to the first terminal of an inductor; a second switch of which the first terminal is configured to be connectable to the first terminal of the inductor and to the second terminal of the first switch and of which the second terminal is configured to be connectable to an application terminal for a low voltage lower than the input voltage; a third switch of which the first terminal is configured to be connectable to the second terminal of the inductor and of which the second terminal is configured to be connectable to the application terminal for the low voltage; a fourth switch of which the first terminal is configured to be connectable to the second terminal of the inductor and to the first terminal of the third switch and of which the second terminal is configured to be connectable to an application terminal for the output voltage; a detector configured to detect occurrence of or a sign of occurrence of an overshoot in the output voltage; and a controller configured to turn on and off the first, second, third, and fourth switches. When occurrence of or a sign of occurrence of an overshoot in the output voltage is detected by the detector, the controller keeps the first and fourth switches off and the second and third switches on. (A seventh configuration.)

With the switching power supply device of the seventh configuration described above, it is possible to suppress an overshoot in the output voltage.

In the switching power supply device of the seventh configuration described above, the detector may also detect disappearance of an overshoot in the output voltage. When disappearance of an overshoot in the output voltage is detected by the detector, the controller may keep the third switch off and the fourth switch on. (An eighth configuration.)

With the switching power supply device of the eighth configuration described above, it is possible to suppress an overshoot in the output voltage reliably until the overshoot in the output voltage disappears.

In the switching power supply device of the eighth configuration described above, during the period after occurrence of or a sign of occurrence of an overshoot in the output voltage is detected by the detector until disappearance of the overshoot in the output voltage is detected by the detector, at least if the second and third switches are on, the controller may keep the first and fourth switches off and turns on and off the second and third switches at a fixed cycle. (A ninth configuration.)

With the switching power supply device of the ninth configuration described above, it is possible to suppress variation of the frequency of noise.

In the switching power supply device of the ninth configuration described above, during the period after occurrence of or a sign of occurrence of an overshoot in the output voltage is detected by the detector until disappearance of the overshoot in the output voltage is detected by the detector, the duration for which the second and third switches are kept off may be a fixed duration. (A tenth configuration.)

With the switching power supply device of the tenth configuration described above, it is possible to suppress an overshoot in the output voltage stably in every cycle.

In the switching power supply device of the tenth configuration described above, during the period after occurrence of or a sign of occurrence of an overshoot in the output voltage is detected by the detector until disappearance of the overshoot in the output voltage is detected by the detector, the duration for which the second and third switches are kept off may be one tenth or less of the fixed cycle. (An eleventh configuration.)

With the switching power supply device of the eleventh configuration described above, it is possible to prevent the time required until an overshoot in the output voltage VOUT disappears from exceeding the permissible range.

In the switching power supply device of any of the first to eleventh configurations described above, a voltage with a frequency of 1.8 MHz or higher but 2.1 MHz or lower may be produced at the connection node between the first and second switches. (A twelfth configuration.)

With the switching power supply device of the twelfth configuration described above, it is possible to reduce nose emission in the AM band as well as switching loss.

According to a third aspect of what has been described above, a switch control device turns on and off: a first switch of which the first terminal is configured to be connectable to an application terminal for an input voltage and of which the second terminal is configured to be connectable to the first terminal of an inductor; and a second switch of which the first terminal is configured to be connectable to the first terminal of the inductor and to the second terminal of the first switch and of which the second terminal is configured to be connectable to an application terminal for a low voltage lower than the input voltage. The switch control device has a first state in which the switch control device keeps the first switch on and the second switch off, a second state that follows the first state and in which the switch control device keeps the first switch off and the second switch on, a third state that follows the second state and in which the switch control device keeps the first and second switches off, and a fourth state that follows the third state and in which the switch control device keeps the voltage at the connection node between the first and second switches lower than in the third state. The switch control device repeats the first, second, third, and fourth states at a fixed cycle.

### (A Thirteenth Configuration.)

With the switch control device of the thirteenth configuration described above, it is possible to achieve high efficiency in a switching power supply device incorporating the switch control device without varying the switching frequency of the switching power supply device incorporating the switch control device.

According to a fourth aspect of what has been described above, a switch control device turns on and off: a first switch of which the first terminal is configured to be connectable to an application terminal for an input voltage and of which the second terminal is configured to be connectable to the first terminal of an inductor; a second switch of which the first terminal is configured to be connectable to the first terminal of the inductor and to the second terminal of the first switch and of which the second terminal is configured to be connectable to an application terminal for a low voltage lower than the input voltage; a third switch of which the first terminal is configured to be connectable to the second terminal of the inductor and of which the second terminal is configured to be connectable to the application terminal for the low voltage; a fourth switch of which the first terminal is configured to be connectable to the second terminal of the inductor and to the first terminal of the third switch and of which the second terminal is configured to be connectable to an application terminal for the output voltage. The switch control device includes: an acquirer configured to acquire the result of detection by a detector for detecting occurrence of or a sign of occurrence of an overshoot in the output voltage; and a suppressor configured to turn on and off the first, second, third, and fourth switches based on the result of detection acquired by the acquirer and, when occurrence of or a sign of occurrence of an overshoot in the output voltage is detected by the detector, keep the first and fourth switches off and the second and third switches on to suppress the overshoot in the output voltage. (A fourteenth configuration.)

With the switch control device of the fourteenth configuration described above, it is possible to suppress an overshoot in the output voltage.

According to what has been described above, a vehicle-mounted appliance includes a switching power supply device of any of the first to twelfth configurations described above or a switch control device of the thirteenth or fourteenth configuration described above. (A fifteenth configuration.)

With the vehicle-mounted appliance of the fifteenth configuration described above, it is possible to achieve high efficiency in a switching power supply device incorporated in the vehicle-mounted appliance without varying the switching frequency of the switching power supply device incorporated in the vehicle-mounted appliance, or to suppress an overshoot in the output voltage of the switching power supply device incorporated in the vehicle-mounted appliance.

According to what has been described above, a vehicle includes the vehicle-mounted appliance configured as described above and a battery for supplying the vehicle-mounted appliance with electric power. (A sixteenth configuration.)

With the vehicle of the sixteenth configuration described above, it is possible to achieve high efficiency in a switching power supply device incorporated in the vehicle without varying the switching frequency of the switching power supply device incorporated in the vehicle, or to suppress an overshoot in the output voltage of the switching power supply device incorporated in the vehicle.

### REFERENCE SIGNS LIST

1A to 1E switching power supply devices according to the first to fifth embodiments
2 acquirer
3 suppressor
C1 output capacitor
C2 capacitance
CNT1 controller
DET1 detector
FB1 output feedback circuit
L1 inductor
LD1 load
SW1 to SW4 first to fourth switches
X vehicle
X11 to X17 vehicle-mounted appliance

1. A switching power supply device configured to buck an input voltage to produce an output voltage, comprising:
a first switch
of which a first terminal is configured to be connectable to an application terminal for the input voltage and
of which a second terminal is configured to be connectable to a first terminal of an inductor;
a second switch
of which a first terminal is configured to be connectable to the first terminal of the inductor and to a second terminal of the first switch and
of which a second terminal is configured to be connectable to an application terminal for a low voltage lower than the input voltage; and
a controller configured to turn on and off the first and second switches,
wherein
the controller has
a first state in which the controller keeps the first switch on and the second switch off,
a second state that follows the first state and in which the controller keeps the first switch off and the second switch on,
a third state that follows the second state and in which the controller keeps the first and second switches off, and
a fourth state that follows the third state and in which the controller keeps a voltage at the connection node between the first and second switches lower than in the third Filed state, and
the controller repeats the first, second, third, and fourth states at a fixed cycle.

2. The switching power supply device according to claim 1, wherein
in the fourth state, the controller keeps the first switch off and the second switch on.

3. The switching power supply device according to claim 1, further comprising:
a third switch
configured to be connectable in parallel with the second switch and
having at least either of a lower on-state resistance and a lower capacitance than the second switch,
wherein
the controller is configured to turn on and off the third switch and
in the fourth state, the controller keeps the first switch off and the third switch on.

4. The switching power supply device according to claim 1, further comprising:
a third switch
of which a first terminal is configured to be connectable to the first terminal of the inductor and to the second terminal of the first switch and
a capacitance
of which a first terminal is connected to a second terminal of the third switch and
of which a second terminal is configured to be connectable to the application terminal for the low voltage,
wherein
the controller is configured to turn on and off the third switch and
in the fourth state, the controller keeps the first switch off and the third switch on.

5. The switching power supply device according to claim 4, further comprising:
a fourth switch configured to be connectable in parallel with the capacitance,
wherein
the controller is configured to turn on and off the fourth switch and
the controller turns on and off the third and fourth switches complementarily.

6. The switching power supply device according to claim 1, further comprising:
a capacitance
of which a first terminal is configured to be connectable to the first terminal of the inductor and to the second terminal of the first switch and
of which a second terminal is configured to be connectable to an application terminal for a variable voltage,
wherein
the controller is configured to control the variable voltage, and
in the fourth state, the controller keeps the first switch off and, by controlling the variable voltage, produces a voltage difference between a first terminal and a second terminal of the capacitance.

7. A switching power supply device configured to buck an input voltage to produce an output voltage, comprising:
a first switch
of which a first terminal is configured to be connectable to an application terminal for the input voltage and
of which a second terminal is configured to be connectable to a first terminal of an inductor;
a second switch
of which a first terminal is configured to be connectable to the first terminal of the inductor and to a second terminal of the first switch and
of which a second terminal is configured to be connectable to an application terminal for a low voltage lower than the input voltage;
a third switch
of which a first terminal is configured to be connectable to a second terminal of the inductor and
of which a second terminal is configured to be connectable to the application terminal for the low voltage;
a fourth switch
of which a first terminal is configured to be connectable to the second terminal of the inductor and to a first terminal of the third switch and
of which a second terminal is configured to be connectable to an application terminal for the output voltage;
a detector configured to detect occurrence of or a sign of occurrence of an overshoot in the output voltage; and
a controller configured to turn on and off the first, second, third, and fourth switches,
wherein when occurrence of or a sign of occurrence of an overshoot in the output voltage is detected by the detector, the controller keeps the first and fourth switches off and the second and third switches on.

8. The switching power supply device according to claim 7, wherein
the detector also detects disappearance of an overshoot in the output voltage, and
when disappearance of an overshoot in the output voltage is detected by the detector, the controller keeps the third switch off and the fourth switch on.

9. The switching power supply device according to claim 8, wherein
during a period after occurrence of or a sign of occurrence of an overshoot in the output voltage is detected by the detector until disappearance of the overshoot in the output voltage is detected by the detector, at least if the second and third switches are on, the controller keeps the first and fourth switches off and turns on and off the second and third switches at a fixed cycle.

10. The switching power supply device according to claim 9, wherein
during a period after occurrence of or a sign of occurrence of an overshoot in the output voltage is detected by the detector until disappearance of the overshoot in the output voltage is detected by the detector, a duration for which the second and third switches are kept off is a fixed duration.

11. The switching power supply device according to claim 10, wherein
during a period after occurrence of or a sign of occurrence of an overshoot in the output voltage is detected by the detector until disappearance of the overshoot in the output voltage is detected by the detector, the duration for which the second and third switches are kept off is one tenth or less of the fixed cycle.

12. The switching power supply device according to claim 1, wherein
a voltage with a frequency of 1.8 MHz or higher but 2.1 MHz or lower is produced at the connection node between the first and second switches.

13. A switch control device for turning on and off:
a first switch
of which a first terminal is configured to be connectable to an application terminal for an input voltage and
of which a second terminal is configured to be connectable to a first terminal of an inductor; and
a second switch
of which a first terminal is configured to be connectable to the first terminal of the inductor and to a second terminal of the first switch and
of which a second terminal is configured to be connectable to an application terminal for a low voltage lower than the input voltage,
wherein
the switch control device has
a first state in which the switch control device keeps the first switch on and the second switch off,
a second state that follows the first state and in which the switch control device keeps the first switch off and the second switch on,
a third state that follows the second state and in which the switch control device keeps the first and second switches off, and
a fourth state that follows the third state and in which the switch control device keeps a voltage at the connection node between the first and second switches lower than in the third state, and
the switch control device repeats the first, second, third, and fourth states at a fixed cycle.

14. A switch control device for turning on and off:
a first switch
of which a first terminal is configured to be connectable to an application terminal for an input voltage and
of which a second terminal is configured to be connectable to a first terminal of an inductor;
a second switch
of which a first terminal is configured to be connectable to the first terminal of the inductor and to a second terminal of the first switch and
of which a second terminal is configured to be connectable to an application terminal for a low voltage lower than the input voltage;
a third switch
of which a first terminal is configured to be connectable to a second terminal of the inductor and
of which a second terminal is configured to be connectable to the application terminal for the low voltage; and
a fourth switch
of which a first terminal is configured to be connectable to the second terminal of the inductor and to a first terminal of the third switch and
of which a second terminal is configured to be connectable to an application terminal for the output voltage;
wherein
the switch control device comprises:
an acquirer configured to acquire a result of detection by a detector for detecting occurrence of or a sign of occurrence of an overshoot in the output voltage; and
a suppressor configured to turn on and off the first, second, third, and fourth switches based on the result of detection acquired by the acquirer and, when occurrence of or a sign of occurrence of an overshoot in the output voltage is detected by the detector, keep the first and fourth switches off and the second and third switches on to suppress the overshoot in the output voltage.

15. A vehicle-mounted appliance, comprising:
the switching power supply device according to claim 1.

16. A vehicle, comprising:
the vehicle-mounted appliance according to claim 15; and
a battery for supplying the vehicle-mounted appliance with electric power.

17. A vehicle-mounted appliance, comprising:
the switching power supply device according to claim 7.

18. A vehicle-mounted appliance, comprising:
the switch control device according to claim 13.

19. A vehicle-mounted appliance, comprising:
the switch control device according to claim 14.
